(19) United States
(12) Patent Application Publication
(10) Pub. No.: US 2009/0018968 A1
(43) Pub. Date: Jan. 15, 2009

(54) Systems, methods, and media for trading securities

(76) Inventors: Gary Ardell, Melrose, MA (US); Matthew T. Byrne, Jersey City, NJ (US)

Correspondence Address: Byrne Poh LLP, 11 Broadway, Ste 865, New York, NY, 10004, US

(21) Appl. No.: 12/032,682

(22) Filed: Feb. 17, 2008

Related U.S. Application Data
(60) Provisional application No. 60/901,919, filed on Feb. 16, 2007.

(51) Int. Cl. G06Q 40/00

(52) U.S. Cl. 705/36 R; 705/37

(57) ABSTRACT

Systems, methods, and media for trading securities are provided. In some embodiments, methods for trading securities are provided, the methods comprising: accessing at least one record of an order in a trading blotter, the order having a security and side; sending a notification message indicating the security and side for the order; searching for a match for the notification message; if a match is found, obtaining a quantity associated with the order; and determining whether the quantity is adequate for executing a trade.

### CROSS REFERENCE TO RELATED APPLICATIONS

This application claims the benefit of U.S. Provisional Patent Application No. 60/901,919, filed Feb. 16, 2007, which is each hereby incorporated by reference herein in its entirety.

### TECHNICAL FIELD

The disclosed subject matter relates to systems, methods, and media for trading securities.

### BACKGROUND

The capital markets are essential components of the world's economies. Through these markets, among other things, companies and governments can raise money to support their operations by selling securities (such as stocks, bonds, etc.) to investors.

Buying and selling of securities can become difficult when a counter-party (or contra) to the trade cannot be located. For example, a trader may have difficulty in locating a counter-party to a trade because the trader is attempting to execute the trade in a different trading system than one or more available counter-parties, because the trader's minimum or maximum quantities are outside the bounds of one or more counterparties, etc.

This difficulty in finding available counter-parties (or liquidity) can also be attributed to a trader being overloaded with tasks to be completed. For example, a trader responsible for trading a large number of different securities may have a difficult time trading each of the securities. This may accordingly limit the liquidity seen by other traders seeking out securities sought to be traded by the trader.

Accordingly, it is desirable to provide new systems, methods, and media for trading securities.

### SUMMARY

Systems, methods, and media for trading securities are provided. In some embodiments, methods for trading securities are provided, the methods comprising: accessing at least one record of an order in a trading blotter, the order having a security and side; sending a notification message indicating the security and side for the order; searching for a match for the notification message; if a match is found, obtaining a quantity associated with the order; and determining whether the quantity is adequate for executing a trade.

In some embodiments, methods for performing a negotiated trade in a security are provided, the methods comprising: checking for unusual activity in the security; waiting a random or semi-random period of time; causing a trader to receive an indication that a negotiated trade has been initiated; determining if a trade offer from the trader is at or better than the mid-point price in the security for a contra party to the trader; if the trade is at or better than the mid-point price, accepting the trade offer; and executing the trade.

In some embodiments, systems for trading securities are provided, the systems comprising: one or more processors that: access at least one record of an order in a trading blotter, the order having a security and side; send a notification message indicating the security and side for the order; search for a match for the notification message; if a match is found, obtain a quantity associated with the order; and determine whether the quantity is adequate for executing a trade.

In some embodiments, systems for performing a negotiated trade in a security are provided, the systems comprising: one or more processors that: check for unusual activity in the security; wait a random or semi-random period of time; cause a trader to receive an indication that a negotiated trade has been initiated; determine if a trade offer from the trader is at or better than the mid-point price in the security for a contra party to the trader, if the trade is at or better than the mid-point price, accept the trade offer; and execute the trade.

In some embodiments, computer-readable media containing computer-executable instructions that, when executed by a processor, cause the processor to perform a method for trading securities are provided, the method comprising: accessing at least one record of an order in a trading blotter, the order having a security and side; sending a notification message indicating the security and side for the order; searching for a match for the notification message; if a match is found, obtaining a quantity associated with the order; and determining whether the quantity is adequate for executing a trade.

In some embodiments, computer-readable media containing computer-executable instructions that, when executed by a processor, cause the processor to perform a method for performing a negotiated trade in a security are provided, the method comprising: checking for unusual activity in the security; waiting a random or semi-random period of time; causing a trader to receive an indication that a negotiated trade has been initiated; determining if a trade offer from the trader is at or better than the mid-point price in the security for a contra party to the trader; if the trade is at or better than the mid-point price, accepting the trade offer; and executing the trade.

### BRIEF DESCRIPTION OF THE DRAWINGS

FIG. 1 is a block diagram of a system in accordance with some embodiments of the invention.

FIG. 2 is an illustration of a user interface for a blotter in accordance with some embodiments of the invention.

FIG. 3 is another illustration of a user interface for a blotter in accordance with some embodiments of the invention.

FIG. 4 is an illustration of a process for identifying crosses in accordance with some embodiments of the invention.

FIG. 5 is an illustration of a user interface for configuring an order for crossing in accordance with some embodiments of the invention.

FIG. 6 is an illustration of a user interface for inviting a trader to negotiate in accordance with some embodiments of the invention.

FIG. 7 is an illustration of another user interface for inviting a trader to negotiate in accordance with some embodiments of the invention.

FIG. 8 is an illustration of a user interface for negotiating in accordance with some embodiments of the invention.

FIG. 9 is an illustration of a process for automatically negotiating in accordance with some embodiments of the invention.

FIG. 10 is an illustration of a user interface for configuring what trade information may be made available to other traders in accordance with some embodiments of the invention.

FIG. 11 is an illustration of a user interface for alerting a trader to near misses in accordance with some embodiments of the invention.

### DETAILED DESCRIPTION

In accordance with various embodiments of the invention, systems, methods, and media for trading securities are provided.

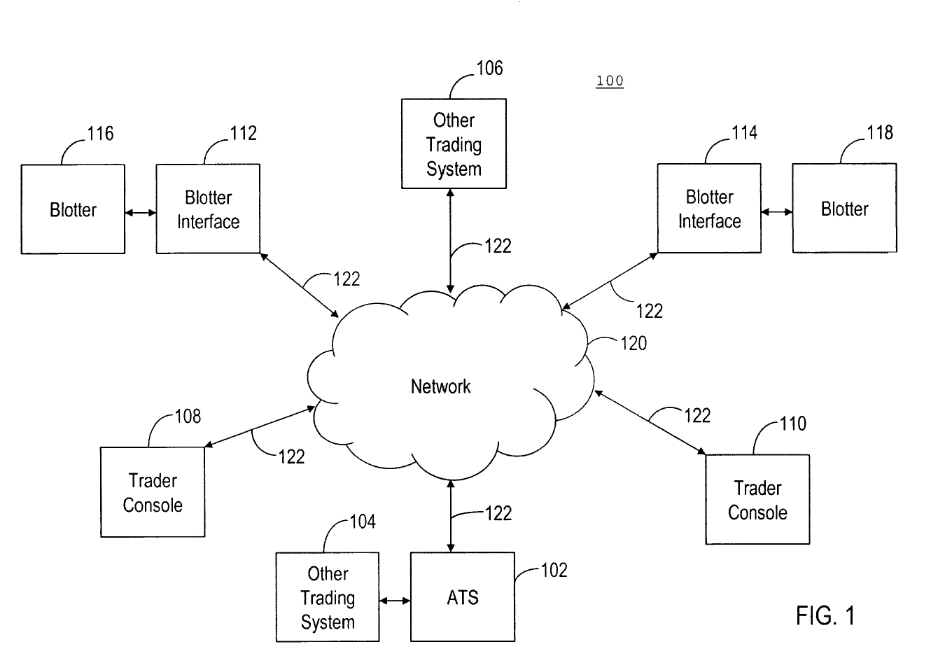

In some embodiments, these systems, methods, and media may be implemented as a crossing engine in an Alternative Trading System (ATS) that identifies and executes orders that can be matched (or “crossed”) in an agency capacity. For example, FIG. 1 illustrates a system 100 that includes an ATS 102 in accordance with some embodiments. As shown, ATS 102 may be coupled to other trading systems 104 and 106, trader consoles 108 and 110, and blotter interfaces 112 and 114 via network 120 and connections 122. ATS 102 may include one or more processors for performing any suitable functions, such as those described herein. Other trading systems may be any suitable mechanisms that can route orders to a crossing engine in ATS 102, and may include one or more processors. Trader consoles 108 and 110 may be any suitable mechanisms for enabling traders to enter trade orders and/or view trade results, and may include one or more processors. Blotter interfaces 112 and 114, as described below, may be any suitable mechanisms for scanning a trader's blotter (e.g., blotters 116 and 118) for potentially crossable orders, and may include one or more processors.

Two basic types of orders that may be processed by a crossing engine for potential crossing are “Designated Orders” and “Uncommitted Orders.” Any other suitable type of order may be included additionally or alternatively. These orders may be received from Institutional, Broker-Dealer, or any other suitable types of traders. The securities eligible for crossing may include any suitable securities, or may be limited to a certain set of securities such as United States equity securities that are listed on the NYSE, Nasdaq, AMEX, and/or any other suitable exchange(s).

A “Designated Order” may be an order that a trader to the ATS specifically sends to the crossing engine to search for a potential match. Such orders may be sent from one of other trading systems 104 and 106, one of trader consoles 108 and 110, or one of blotters 116 and 118 via blotter interfaces 112 and 114. Upon receipt of the Designated Order, the crossing engine may scan its order book for a possible match (i.e., an order for the opposite side of the trade). If no match exists in the book, that trader order may then reside in the crossing engine until a matching order is received or the trader cancels the order.

An “Uncommitted Order” may be an uncommitted order on a trader's trade blotter 116 or 118. If a trader elects to participate in crossing by means of Uncommitted Orders, the trader's open (unexecuted) orders on its trading blotter or order management system (OMS) blotter may be scanned to identify possible cross scenarios based on security symbol and side. This functionality—scanning a trader's order blotter for possible crosses—may be referred to as “Blotter Scraping.” Scanning may occur continuously or periodically. As shares are committed to specific crosses, or are traded through other means, the shares displayed in the blotter may reflect these transactions.

In some embodiments, orders in a trader's trading blotter may be mirrored in a mirror blotter that is part of a blotter interface 112 or 114. The mirror blotter may include all Uncommitted Orders, or only certain orders permitted by the trader. As changes are made to the original blotter and mirror blotter, those changes may be transferred to the other.

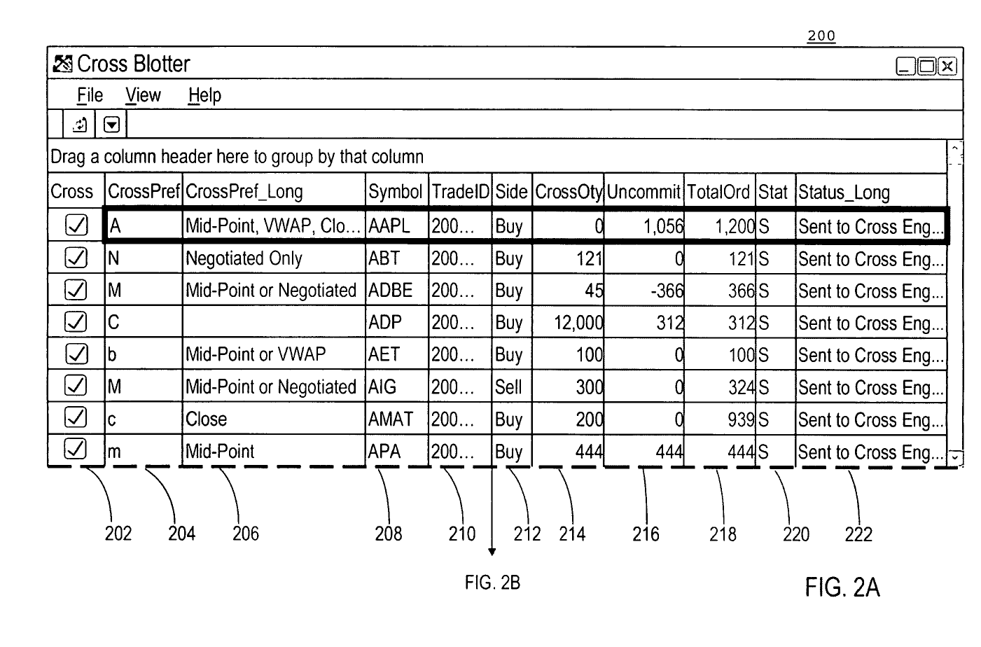

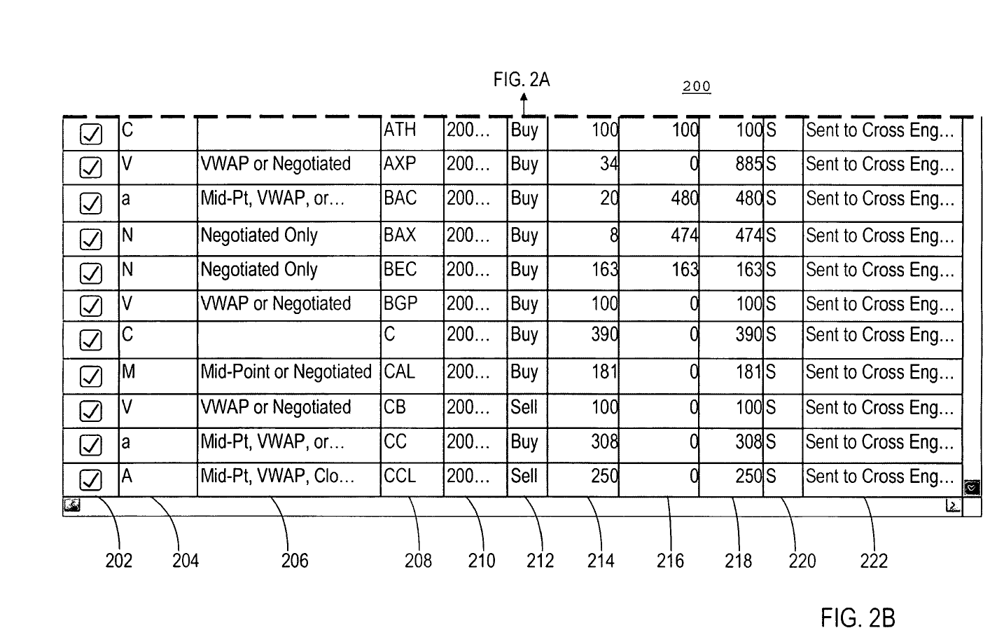

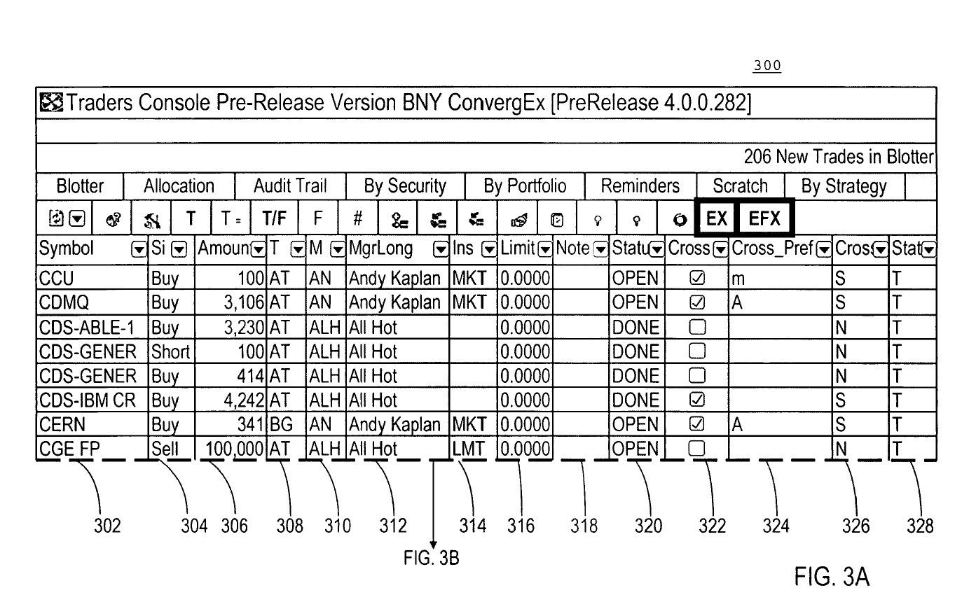

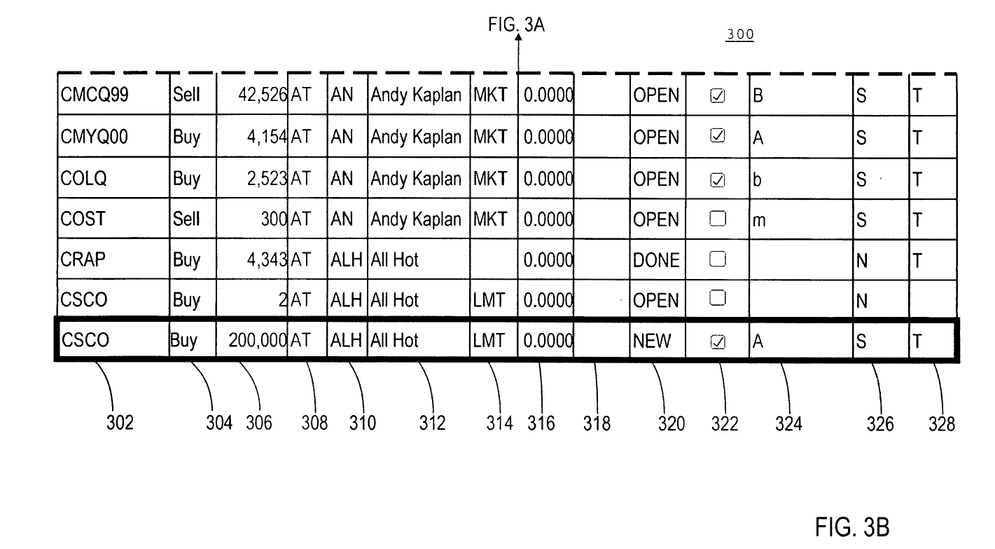

Two examples of trading blotters are illustrated in FIGS. 2 and 3. As shown, in blotter 200 of FIG. 2, for different orders, the blotter interface may include a cross indicator 202, cross preference indicators 204 and 206, a symbol indicator 208, a trade identifier 210, a side indicator 212, a cross quantity indicator 214, an uncommitted quantity indicator 216, a total order quantity indicator 218, and status indicators 220 and 222. Cross indicator 202 may be used to indicate whether the corresponding order is available for potential cross by the crossing engine. Cross preference indicators 204 and 206 may be used to indicate the manner in which a cross of the order can be executed. For example, indicators 204 and 206 may indicate that a cross may be automatically executed at the Midpoint price, Volume Weighted Average Price, Close price, Open price, etc., and/or may be negotiated. Trade identifier 210 may indicate a unique number associated with the order. Side indicator 212 may indicate which side of the trade the order is for (e.g., buy or sell). Cross quantity indicator 214 may indicate the size of the order exposed to potential matches in the crossing engine. Uncommitted quantity indicator 216 may indicate the size of the order that is uncommitted. Total order quantity indicator 218 may indicate the total order size. Status indicators 220 and 222 may indicate the status of the order (e.g., that the order has been sent to the crossing engine).

FIG. 3 illustrates another example of a trading blotter 300 in accordance with some embodiments. As shown, blotter 300 may include for each order (e.g., as shown here in each row) a symbol indicator 302, a side indicator 304, an amount indicator 306, a trader indicator 308, a manager indicators 310 and 312, an instruction indicator 314, a limit indicator 316, a notes field 318, a status indicator 320, a cross indicator 322, a cross preference indicator 324, a cross status indicator 326, an allocation status indicator 328. Symbol indicator 302 may indicate a symbol for a security associated with the order. Side indicator 304 may indicate a side (e.g., buy or sell) associated with an order. Amount indicator 306 may indicate the total size of trade. Trader indicator 308 may indicate the trader associated with the order. Manager indicators 310 and 312 may indicate a manager associated with the order. Instruction indicator 314 may indicate pricing instructions (e.g., market or limit) associated with the order. Limit indicator 316 may indicate a limit price associated with the order. Notes field 318 may indicate notes associated with the order. Status indicator 320 may indicate the status (e.g., open, done, new, etc.) of the order. Cross indicator 320 may indicate whether the order is available to be exposed to potential trades in the crossing engine. Cross preference indicator 324 may indicate that a cross may be automatically executed at the Midpoint price, Volume Weighted Average Price, Close price, Open price, etc., and/or may be negotiated. Cross Status 326 may indicate the status of the trade in regard to the cross (e.g., “S” may indicate sent, “N” may indicate not sent, “D” may indicate done, etc.). Allocation Status 328 may indicate whether a target allocation has been made for the trade.

Both Designated Orders and Uncommitted Orders may be un-priced. Traders may instead designate their orders to be executed at prices derived from the National Best Bid and Offer (“NBBO”) for the particular security at the time of execution (i.e., Bid, Midpoint, or Ask), or at the Opening Price, Closing Price or Volume Weighted Average Price (VWAP) for the security. Traders may also place a limit price on their orders, which may then be used by the crossing engine to determine whether a potential match, based on current market conditions, is available, even though the price of an actual trade may be derivative of the NBBO at the time of the trade, or the opening, closing or available VWAP price.

The VWAP price for orders executed through the crossing engine may be the full day VWAP, which is calculated after the close of trading. Alternatively, VWAP orders executed after the open may be crossed at the available VWAP calculated from the time of the execution through the close. VWAP orders may be submitted at any time, but once they are executed, they may be prevented from being cancelled by the trader. In addition, short sale orders for VWAP trades may be prohibited from being executed through the crossing engine.

In some embodiments, an order may only be permitted to be specified as an Opening Price order if it is submitted to the crossing engine prior to the beginning of trading in that security on each trading day. Orders choosing to receive the Closing Price may be required to be submitted to the crossing engine by 3:59:59 p.m. ET on each trading day. Orders residing in the crossing engine at the end of the normal trading day (i.e., 4:00 p.m. ET) may be cancelled. Normal market hours with automated mid-point orders entered before the open may be crossed at the official primary-market opening price

In some embodiments, Designated Orders and Uncommitted Orders may be received by the crossing engine in the form of notification messages. Notification messages may include a client identifier, an order identifier, a trader identifier, a symbol, and a side (e.g., buy or sell). Notification messages do not include quantity. Other types of messages may be used to provide orders to the crossing engine in various embodiments.

Using the notification messages or other messages, the crossing engine can create lists of securities that are available for crossing. By comparing security and side, the crossing engine can determine if it has any potential matches.

If the crossing engine identifies a possible match, it may then send a polling message requesting from the trading blotter interface (or mirror blotter) information relating to the potential size of the traders' open orders in that security (e.g., the unexecuted share amounts that exist on the traders' trade blotters). The polling messages may include the order identifier from the notification message. In response to the polling message, the blotter interface may send back to the crossing engine an update message. The update message may include an order identifier, a quantity, a minimum quantity, a maximum quantity, crossing instructions, executed share information, average price information, execution vectors, trading instructions, and any other suitable parameters. The update message, however, does not include symbol or side. Other types of messages than polling and update messages may additionally or alternatively be used.

If the crossing engine determines that there are adequate shares eligible to be crossed, it may then proceed based upon whether the trade is to be automatically executed or negotiated, as described below.

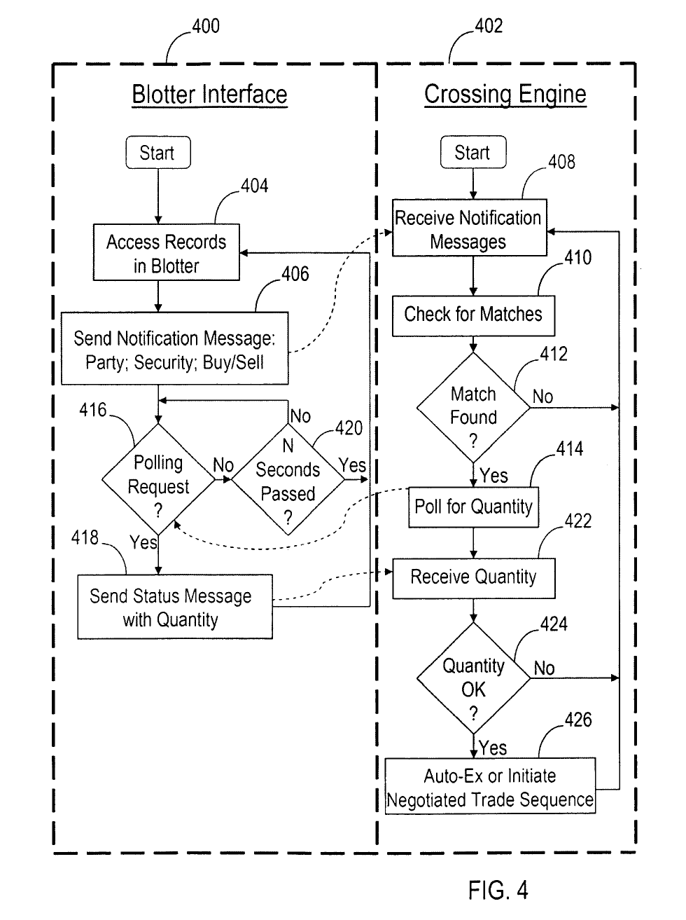

An example of the flow of message between the blotter interface and the crossing engine is illustrated in FIG. 4. As shown, a process 400 may be performed in the blotter interface, and a process 402 may be performed in the crossing engine. At 404, the blotter interface may access records in the blotter. Notification messages may then be sent to the crossing engine at 406. These messages may include party, security, side (e.g., buy/sell) information. At 408, the notification message may be received by the crossing engine. The crossing engine may then check at 410 for matches between the notification message and any other notification messages, orders, or other trade order indicators. If a match is not found, at 412, process 402 may loop back to 408. Otherwise, process 402 may poll the blotter interface for quantity information at 414. In response to this polling inquiry, at 416, process 400 may proceed to 418 to send a status message with quantity information to the crossing engine. Between polling inquiries, process 400 may wait by looping between 416 and 418, and branch to 404 periodically to check the records in the blotter. In response to the status message, the crossing engine may receive the quantity information at 422. If it is determined at 424 that the quantity is sufficient to execute a trade, process 402 may automatically execute the trade or begin a negotiated trade sequence (as described below) at 426. Otherwise, process 402 may loop back to 408.

In some embodiments, the trader may have the ability to decide how they would like to execute possible crossing transactions when they are presented by the crossing engine prior to any executions being completed. The two variations of the order types are “Negotiation” and “Auto-Executable (Auto-Ex).” An Auto-Ex order may be for any size. If a trader selects Negotiation, however, the trader may be obligated to trade no less than a minimum number of shares. A trader may also place a minimum and/or a maximum share amount for each cross. The pricing options for orders may be limited based upon whether an order is an Auto-Ex or a Negotiated order.

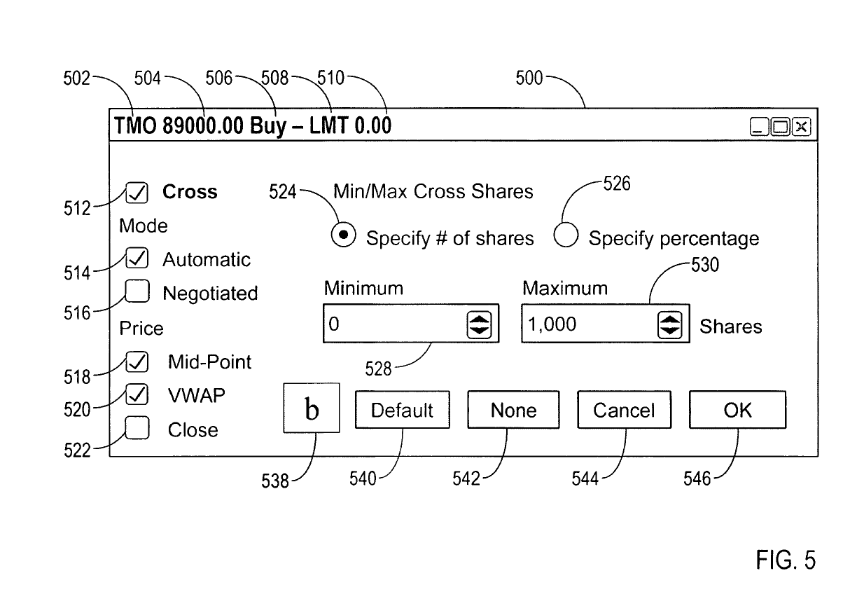

An example of a user interface for configuring orders for trading is shown in FIG. 5. As illustrated in FIG. 5, user interface 500 may include a symbol indicator 502, a size indicator 504, a side indicator 506, instruction indicator 508, and a limit price 510. Symbol indicator 502 may indicate a security for the order being configured. Size indicator 504 may indicate the size of the order. Side indicator 506 may indicate a trade side (e.g., buy/sell) for the order. Instruction indicator 508 may indicate pricing instructions for the order (e.g., market or limit). Limit price 510 may indicate a limit price for the order.

User interface 500 may also include a cross indicator 512, an automatic mode indicator 514, a negotiated mode indicator 516, a midpoint pricing indicator 518, a VWAP pricing indicator 520, and a close pricing indicator 522. Cross indicator 512 may be used to indicate that the order is available to be crossed in the crossing engine. Automatic mode indicator 514 may be used to indicate that the crossing may be performed automatically. Negotiated mode indicator 516 may be used to indicate that the crossing may be performed using the negotiated mode. Midpoint pricing indicator 518 may be used to indicate that the crossing may be priced at the midpoint of the NBBO. VWAP pricing indicator 520 may be used to indicate that the crossing may be priced using VWAP pricing. Close pricing indicator 522 may be used to indicate that the crossing may be priced using the closing price.

User interface 500 may further include radio buttons 524 and 526 for specifying how minimum and maximum shares for cross are to be specified, a minimum share field 528, a maximum share field 530, crossing preference indicator 538, default button 540, none button 542, cancel button 544, and OK button 546. Buttons 524 and 526 may be used to specify whether fields 528 and 530 represent quantities of shares or percentages, respectively. Fields 528 and 530 may be used to specify minimum and maximum quantities for crossing, respectively. Crossing preference indicator 538 may be used to indicate the type of crossing preference selected based on indicators 512, 514, 516, 518, 520, and 522. Default button 540 may be used to select default settings in interface 500. None button may be used to indicates that no constraints are to be placed on crossing of the order—e.g., indicators 512, 514, 516, 518, 520, and 522 may all be checked, and fields 528 and 530 may be left blank. Cancel button 544 may be used to cancel changes made in interface 500. OK button 546 may be used to accept changes made in interface 500.

In automatic execution mode, crosses identified in the crossing engine may occur automatically. For example, in some embodiments, if a trader elects to Auto-Ex on any possible crosses, it will have entered some size, pricing, and contra-side criteria that will allow matches to be automatically executed (i.e., crossed with other traders' orders or open orders that meet the Auto-Ex criteria set by the trader). As another example, if both sides of a possible cross are set for Auto-Ex and they meet each others' share, price, and contra-side requirements, they will both be executed at the agreed-upon price automatically. Because these Auto-Ex orders are binding indications which are automatically converted into orders for execution by the crossing engine, there is no need for either an invitation to negotiate (as described below) to be sent or a negotiation to occur before execution in some embodiments.

When a cross is found for a negotiated trade, an “invitation” to negotiate a transaction may then be sent to both traders in some embodiments. These invitations may be anonymous, may display only the security symbol involved and the side (i.e., buy or sell) of the potential contra-party, and may be sent only to traders for which matches relating to their open blotter orders are possible. An invitation may only inform the trader that a possible match in a particular security may exist. In some embodiments, it will not identify the contra-side trader, the size of the contra-side interest, or the price category specified by the contra-side trader. Only if the trader subsequently enters into a negotiation with the contra-party or otherwise agrees to a trade through the crossing engine will an actual order be submitted for execution in some embodiments.

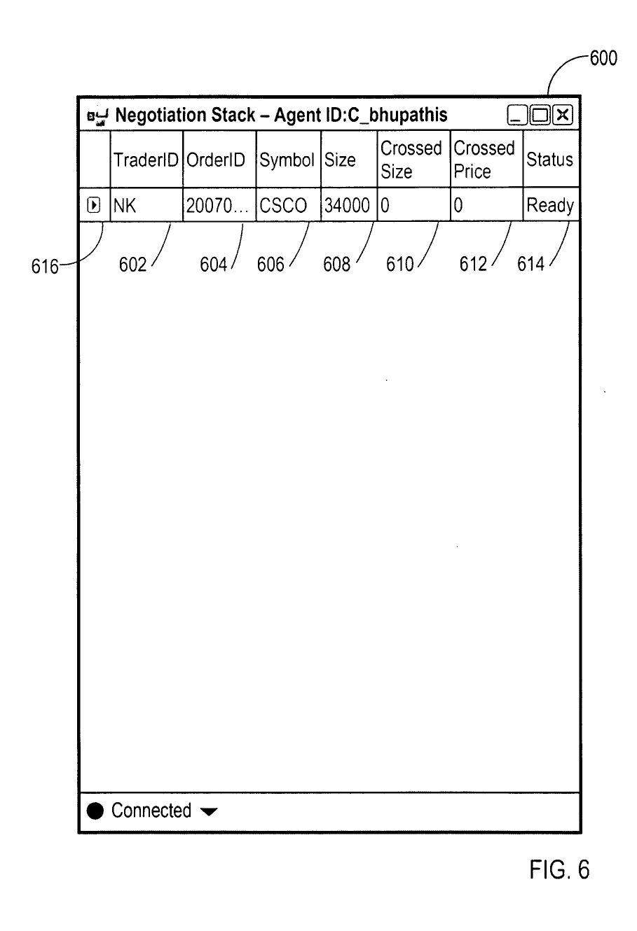

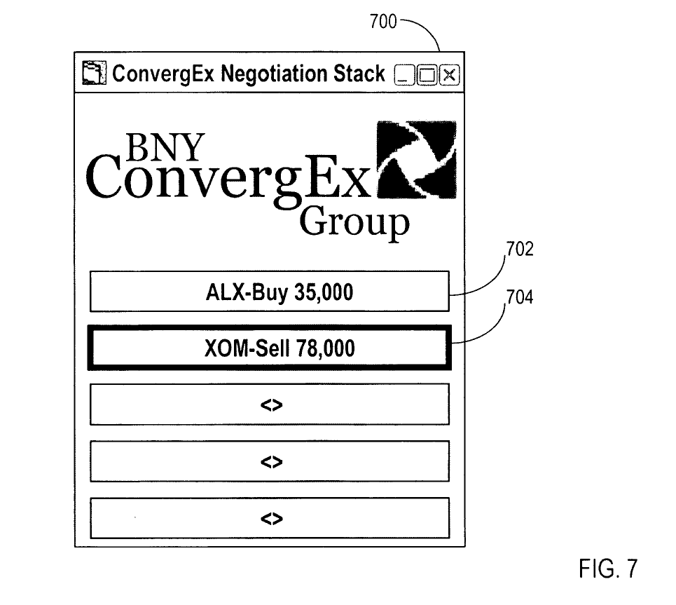

Two examples of invitation interfaces are shown in FIGS. 6 and 7. As illustrated in FIG. 6, an interface 600 may present, in a row 616, a trader identifier 602, an order identifier 604, a symbol identifier 606, a size identifier 608, a crossed-size indicator 610, a crossed-price indicator 612, and a status indicator 614. Trader identifier 602 may identify the trader on the opposite side of the negotiation. In some embodiments, identifier 602 may be obscured. Order identifier 604 may identify the negotiation for record keeping. Symbol identifier 606 may identify the security being traded. Size identifier 608 may identify the size of the trade. Crossed-size indicator 610 may indicate the size already crossed. Crossed-price indicator 612 may indicate the price of previous crosses. Status indicator 614 may indicate the status of a negotiation. By selecting row 616, a trader may enter a negotiation for the corresponding order.

FIG. 7 illustrates another example of an invitation interface 700. As shown, interface 700 may display multiple negotiation opportunities 702 and 704. For each of these opportunities, the symbol, side, and size may be displayed. By selecting one of these opportunities, the trader may enter a negotiation for the corresponding order.

Either party may be permitted to discard the invitation at any point before both parties accept the invitation.

If both traders accept the invitation to negotiate within a pre-determined time frame, a negotiation window may pop up on both traders' desktops with a negotiation order ticket. This time frame to accept may be any suitable length of time and may apply equally (or not) to all negotiations within the crossing engine. For example, the period may be between 20 and 45 seconds, but this period may be lengthened or shortened. The negotiation window may show the minimum of the two trader's maximum shares limits, however, the trader may be permitted to increase the number of shares committed to a cross beyond his original maximum shares limit (or even his uncommitted shares).

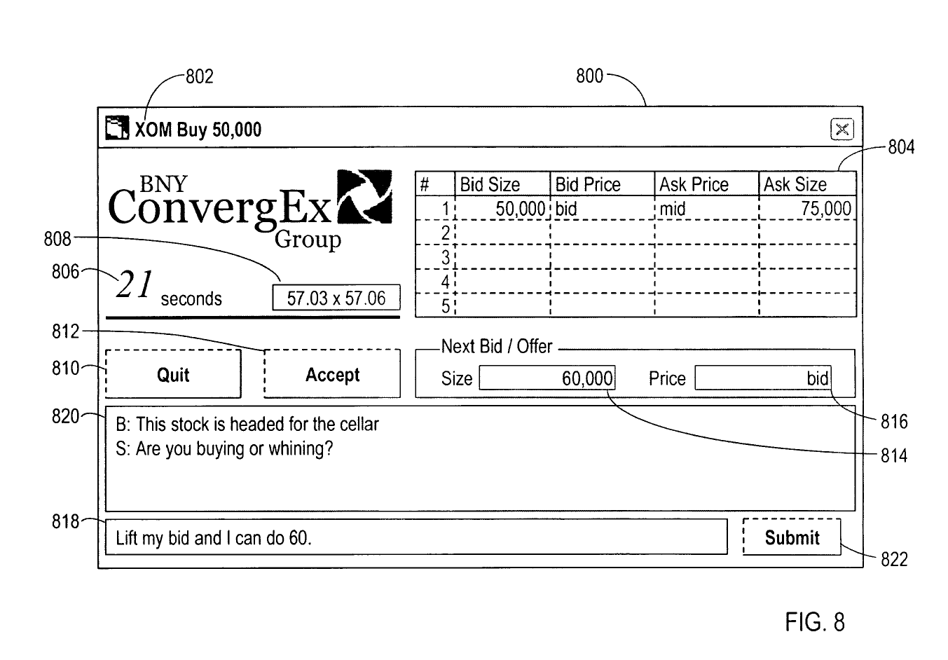

An example of a negotiation window 800 is shown in FIG. 8. As illustrated, a security, side, and size 802 may be indicated for the negotiation. A history panel may show bid size, bid price, ask price, and ask size for the negotiation. A timer 806 may indicate the time remaining in the negotiation. A spread indicator 808 may indicate the spread in the market for the security being negotiated. For example, 57.03 is the current bid price and 57.06 is the current ask price in the market for the security being negotiated. Quit and accept buttons 810 and 812 may be used to quit the negotiation and accept the other side's offer, respectively. Size field 814 and price field 816 may be used to indicate the size and price basis for a trader's offer, respectively. Text entry field 818 may be used to enter a message to the other trader and that message may be transmitted by pressing submit button 822. The text messages of each trader may then be presented in field 820.

Once both parties accept the invitation to negotiate a trade, they may both be obligated to execute some minimum trade of the security (e.g., 10,000 shares at the midpoint of the NBBO) even if the Negotiation is ended without coming to an agreement on the negotiations. This trade may be executed immediately, or only may be executed if a suitably large negotiated trade is not executed. The size of the minimum trade may be based on a fixed size, a size adjusted for a total trade dollar amount, a limited randomly selected amount, and/or any other criteria or criterion.

In a negotiation session, which may be limited to some maximum period of time (e.g., 45 seconds), traders may negotiate the size and price (e.g., bid, NBBO midpoint, or ask) of their crosses. Limited text messaging may be permitted between traders in a negotiation session, and any communications may be maintained in accordance with applicable books-and-records requirements (e.g., such as the SEC and SRO books-and-records requirements).

As suggested above, the negotiations may be limited to one-on-one negotiations. If more than one trader on the same side of the market has an order residing in the crossing engine or a blotter entry that is eligible for a negotiation, the selection of the trader that will be given the opportunity to participate in the negotiation may be based on (1) the larger sized order, (2) time of entry of the order into the crossing engine's order book, and/or (3) any other suitable criteria or criterion. For example, if there is one buyer of 100,000 shares of a certain security and two sellers of 50,000 shares and 300,000 shares, respectively, the 300,000-share seller may be given the invitation to negotiate and will have the first opportunity to negotiate with the buyer. If the negotiating seller and buyer cannot complete a cross, or do not fill the buyer's quantity requirement, the 50,000-share seller may then be given the opportunity to negotiate with the buyer. Similarly, if there are three Designated Orders to buy 50,000 shares each of a security residing in the crossing engine order book, and one seller has an Uncommitted Order of 100,000 shares, the Designated Order that was entered into the book first may be given a pop-up invitation to negotiate first. After one negotiation session is concluded, there may be a subsequent period of time (e.g., 10 seconds) during which the trader whose open order has not been completely filled during the negotiation will have the opportunity to revise the terms of its open order prior to an invitation being sent to the next contra-side trader in time order.

If there is one trader on one side of the market and three (or any number more than one) traders on the contra-side of the market, invitations to negotiate may be sent to both the buyer and the seller with priority. If, however, the single buyer is the first to respond to the indication, the crossing engine may then send invitations to all other potential sellers. The first seller to respond to the invitation may be permitted to enter into the negotiation with the buyer. To the second seller to respond, it may look like the other side has not yet accepted.

The number of negotiation sessions that may occur may be limited based on any suitable criteria or criterion. For example, a trader may only be permitted to be involved in one negotiation at any given time. As another example, only one negotiation per security may be permitted at any given time. As yet another example, only two parties may be permitted to participate in a negotiation at any given point in time.

If both parties of the negotiation agree on the number of shares to be executed and a price (e.g., the Bid, the Ask or the Midpoint of the NBBO), the cross is considered a potential trade. Once considered a potential trade, the cross may then be checked against the NBBO, time stamped and reported, and then cleared, settled, submitted for regulatory reporting requirements, and processed in any other suitable ways as known in the art.

In some instances, both parties seeking to execute trades in a security may be in a near miss scenario. For example, if one side of the potential match is designated as eligible for Auto-Ex and the other side is designated as eligible for negotiation, the crossing engine may send a message (an Indication of Interest (IOI)) to the trader that has chosen Auto-Ex to ask him to change his status to Negotiate if he would like to be eligible to enter a Negotiation session. If the Auto-Ex user changes the status of his order to Negotiate, the crossing engine may delete the trader's Auto-Ex record and replace it with a Negotiate record. While near misses may occur when one party is configured for Auto-Ex and the other for Negotiate, near misses may occur in many other situations. For example, a near miss may occur when the bases for pricing between two parties are different, when minimum and maximum size limits are slightly different, etc. As another example, near misses can also occur when one or both traders have not permissioned an order for crossing at all. In this case, one or both traders may get an IOI helping them to see the benefit of making the uncommitted shares of their orders available for crossing. Yet another example of a near miss is when it is detected that a trader has been active in a security for days but has no order for that security in his blotter today. In this case, if the crossing engine can see an order in another blotter that might be useful to the trader, it can provide an 101 essentially saying “I noticed you have been active in this side of this name for days. If you are still interested, I may have a contra for you.”

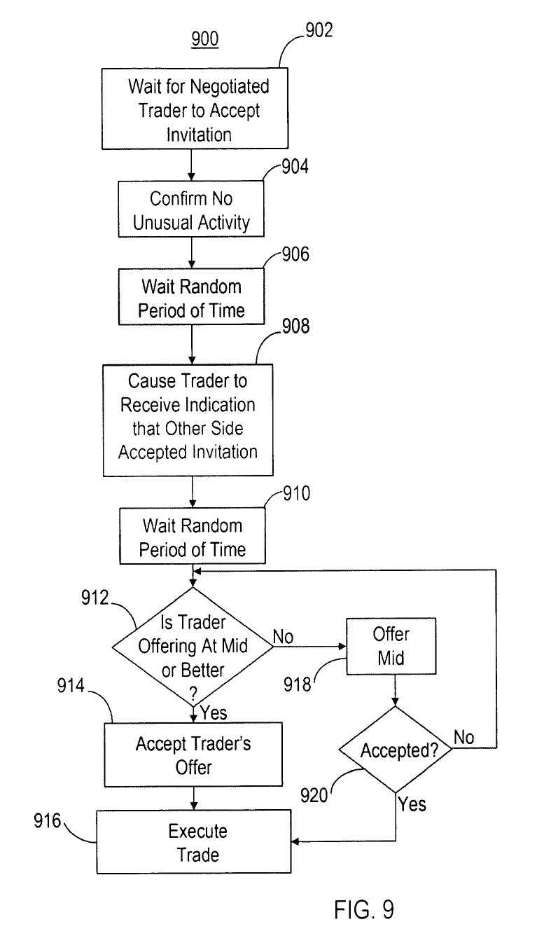

In some embodiments, near misses of crosses involving an Auto-Ex order and a Negotiated order may be completed by automatically processing the Auto-Ex order as a negotiated trade. For example, a process may automatically negotiate on behalf of the Auto-Ex order against a trader in a negotiated trading order. This may occur for example as illustrated in FIG. 9. As shown, a process 900 may be activated when a near miss is detected between an Auto-Ex order and a Negotiated order. The process may wait at 902 for the Negotiated trader to accept his invitation. After the invitation is accepted, process 900 may look for any usual activity associated with the cross at 904. For example, the process may look for extraordinary volatility in price or size for the security, may look at news feeds for any indication that the security is going to radically change price, may look for larger-than-normal spreads in the price for the security, etc. If there is no unusual activity, next at 906, the process may wait a random period of time. This wait may be used to prevent the Negotiated trader from knowing that he is negotiating against a process. At 908, process 900 may cause the trader to receive an indication that the other side (the process) accepted the invitation. Next, at 910, the process may once again wait a random period of time. At 912, the process may determine whether the trader is offering to trade at a price that is at mid or better (for the Auto-Ex trader). If so, the process may accept the Trader's offer at 914 and execute the trade at 916. Otherwise, the process may offer the price at mid at 918 and then determine at 920 if the trader accepted and execute the trade if so, or loop back to 912 otherwise.

Each trader may be permitted to define how much information may be shared (and therefore received) with IOIs. IOIs can be prevented from being sent to a trader when a cross would not be useful to that trader (e.g., because it is too small).

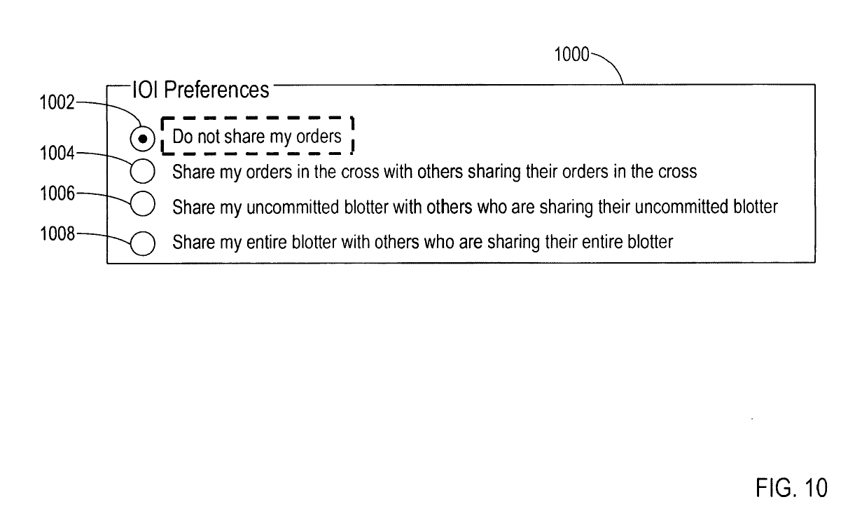

An example of a window 1000 for configuring IOIs is shown in FIG. 10. As illustrated, a trader may be able to indicate using radio buttons 1002, 1004, 1006, and 1008, respectively to not share orders, share order in the crossing engine with other sharing their orders in the crossing engine, share uncommitted blotter with others who are sharing their uncommitted blotter, and share their entire blotter with others who are sharing their entire blotter. Any other suitable configuration options may be used additionally or alternatively.

Each trader may be able to set different trust levels depending on how much information about their side can be revealed to another trader in near miss situations. For example, a trader can choose to be 100% dark—share nothing and get nothing (trust level: 0); can share information about orders in the cross (trust level: 1); can share information about un-committed shares in the trader's blotter but not currently authorized for crossing (trust level: 2); can share information about the trader's full un-executed blotter (trust level: 3). Other sharing options may be: a trader remains completely dark; a trader shares only in the case of near misses (e.g., based on price); a trader only shares when suggestions to add orders to the crossing engine would be made; a trader only shares when the crossing engine would recommend that the trader retract unfilled orders from some other market and cross them in the crossing engine instead.

Information to be shared can be restricted to other parties defined by a given trader. Such limitations may equally limit the parties from which the trader will receive information.

While information sharing limitations may be configured to be symmetric as illustrated above, the limitations may additionally or alternatively be asymmetric in some or all cases. For example, a party may receive more information from others than he is providing. Other parties may be required to have configured their settings to allow such asymmetry.

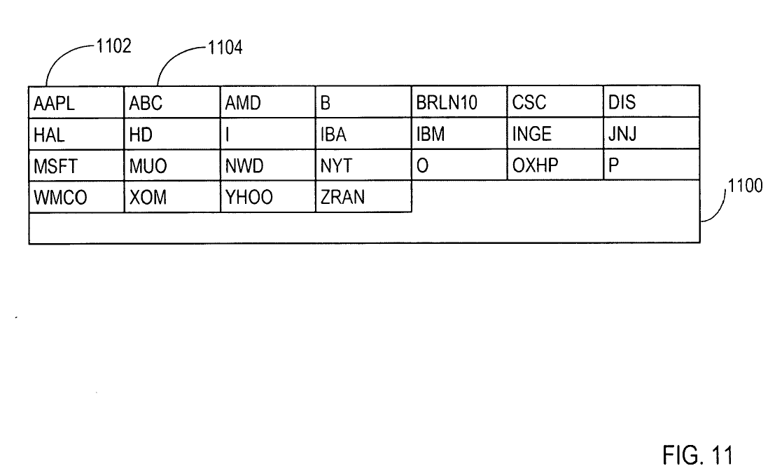

In some embodiments, an IOI billboard may be provided within a trader's blotter to notify the trader of a near miss in the security they have interest in getting crossed. For example, such a billboard 1100 may appear as shown in FIG. 11. When a near miss occurs, the corresponding symbol (e.g., symbol 1102 or 1104) for the security may blink. The trader can then click on the symbol to see the details of the missed opportunity, and/or double-click the symbol to bring the trader to the order in his blotter so that he can adjust the crossing preferences for that order.

The ATS may allow traders to select the types of contra-side traders with which they interact. For example, if an Institutional trader does not want to cross with or receive invitations regarding broker-dealers, it can put that “rule” into its default criteria when it becomes a trader to the system. Furthermore, a trader may choose to not conduct future negotiations with particular contra-parties based on the interactions between the parties during such negotiations (e.g., the trader believes a contra-party did not negotiate in good faith or otherwise exhibited objectionable behavior). In such a case, a trader wishing to preclude such future negotiations can contact the provider of the ATS after a negotiation and request that it no longer be notified for possible negotiations with that particular contra-party. This may be accomplished by giving the identification number of the trade associated with a negotiation with that other trader (e.g., the trade identification number for the immediately executed 10,000 trade with that contra-party or for the subsequently negotiated trade with that contra), or by pressing a button in the negotiation user interface. In order to insure anonymity, the trader may be prevented from learning the identity of the contra-party.

The crossing engine may also “score” traders into any number (e.g., three) of categories (e.g., category 1 being the best and category 3 being the worst) based on (1) their negotiated crossing behavior (e.g., how often the trader elects to participate in a negotiation after receiving an invitation, and how often a cross negotiation results in success), (2) a trader momentum score, and/or (3) any other suitable metric. The trader momentum score may be based on price movement in a security after a cross. For example: initiation and negotiated-price crosses may be scored against the available VWAP after the cross is done; close price crosses may be marked against the next-day VWAP for the first half hour of trading; and VWAP crosses may be marked against a market-impact adjusted initiation price. The score for each trader may be the trade-value weighted average of all the crosses he has done. There may be any suitable number of levels to this element. For example, with three levels, the traders may be categorized as: non-price-informed value-based order flow; momentum trading; and heavily momentum-based trading. As another example, traders can be categorized as: value traders; price neutral traders; moderately momentum traders; and aggressively momentum traders. New traders to the crossing engine may be assigned a score in the middle of the score range (e.g., “2”). Traders' scores may be reviewed and updated on a periodic basis.

Traders may be able to use these reputation scores to define their inclusion and exclusion lists for all or only certain orders. For example, these inclusion and exclusion lists can be used to manage a trader's adverse selection. The traders may be prevented, however, from excluding other traders with scores matching and/or better than their own (with the exception of individual contra-sides that they have reported to the crossing engine for exclusion and class exclusions). Traders may be prevented from learning the identities of any other trader in any of the categories.

While an ATS may be implemented with only a single crossing engine, in some embodiments multiple crossing engines may be used, and/or the crossing engine described herein may send information about crossable orders to other crossing engines, or receive information about crossable orders from other crossing engines, in order to identify a match. For example, where two matching orders originate in two different crossing engines, the order from each engine may be shared with the other engine, and each engine may individually identify a match and then cooperate to execute a trade (either automatically or through negotiation, for example, as described above). Alternatively, one of the two engines could be designated as being responsible for matching and/or executing trades.

Multiple crossing engines may be implemented as part of a peer-to-peer environment where there is no central crossing engine, or even separate distributed crossing engines, but instead crossing occurs at the trading blotter interfaces. In such cases, suitable encryption and hashing of order data may be performed to protect the confidentiality of the order data. Each crossing engine may be implemented in one or more processors.

Various crossing rules can be used in some embodiments. For example, default crossing rules can be defined for all orders, for certain orders, etc. For example, orders for under 10 k shares can be configured for automatic mid-point crossing, orders for 10 k to 50 k shares can be handled via negotiated trading, and orders for over 50 k shares can require explicit trader inspection. The trader may be permitted to change the instructions on a ticket-by-ticket basis at any time, to define a universe of crossing parties with inclusion and exclusion lists, to try to make all automated crossing work before it tries any negotiated orders for a given security, etc. In automated crossing: priority may be given to “orders” with the greatest number of shares available to cross, and mid-point pricing may be favored over VWAP, which may be favored over close pricing. In negotiated trading, the trader can use a maximum shares limit to hint to the crossing engine the number of shares he would like to get traded.

In some embodiments, different Designated and/or Uncommitted orders can by modified in concert based upon crossing rules. For example, in a portfolio trade where the trading behavior for one stock depends on the progress of another stock, the crossing engine can coordinate crossing of orders based upon that relationship.

In some embodiments, orders designated in an OMS as to be traded algorithmically may instead by traded using a crossing engine. In such a case, for example, the crossing engine may determine that a better trade can occur in the crossing engine than is available via algorithmic trading. The crossing engine may then instruct the OMS to decrease the number of shares designated for algorithmic trading (or delete the algorithmic trading designation altogether) and then complete a cross.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A method for trading securities comprising:
accessing at least one record of an order in a trading blotter, the order having a security and side;
sending a notification message indicating the security and side for the order;
searching for a match for the notification message;
if a match is found, obtaining a quantity associated with the order; and
determining whether the quantity is adequate for executing a trade.

2. The method of claim 1, further comprising automatically executing a trade for the order.

3. The method of claim 1, further comprising inviting two parties corresponding to the trade to negotiate.

4. The method of claim 1, wherein obtaining the quantity comprises polling for quantity and receiving a status message.

5. The method of claim 1, further comprising determining whether two non-matching orders are similar and notifying a trader of that the orders are similar.

6. The method of claim 5, further comprising providing an interface of symbol names and modifying the display of a symbol name for a security if two similar orders in that security are identified.

7. The method of claim 6, wherein modifying the display comprising blinking the symbol name.

8. The method of claim 1, receiving a user selection specifying how orders of a trader are to be shared.

9. The method of claim 1, wherein the at least one record of the order is for an uncommitted order.

10. The method of claim 1, wherein searching for a match for the notification message comprises comparing the notification message to a designated order.

11. The method of claim 1, wherein searching for a match for the notification message comprises comparing the notification message to an uncommitted order.

12. A method for performing a negotiated trade in a security comprising:
checking for unusual activity in the security;
waiting a random or semi-random period of time;
causing a trader to receive an indication that a negotiated trade has been initiated;
determining if a trade offer from the trader is at or better than the mid-point price in the security for a contra party to the trader;
if the trade is at or better than the mid-point price, accepting the trade offer; and
executing the trade.

13. The method of claim 12, further comprising making a trade offer at the mid-point price for the security.

14. A system for trading securities comprising:
one or more processors that:
access at least one record of an order in a trading blotter, the order having a security and side;
send a notification message indicating the security and side for the order;
search for a match for the notification message;
if a match is found, obtain a quantity associated with the order; and
determine whether the quantity is adequate for executing a trade.

15. The system of claim 14, wherein the one or more processors also automatically execute a trade for the order.

16. The system of claim 14, wherein the one or more processors also invite two parties corresponding to the trade to negotiate.

17. The system of claim 14, wherein obtaining the quantity comprises polling for quantity and receiving a status message.

18. The system of claim 14, wherein the one or more processors also determine whether two non-matching orders are similar and notify a trader of that the orders are similar.

19. The system of claim 18, wherein the one or more processors also provide an interface of symbol names and modify the display of a symbol name for a security if two similar orders in that security are identified.

20. The system of claim 19, wherein modifying the display comprising blinking the symbol name.

21. The system of claim 14, wherein the one or more processors also receive a user selection specifying how orders of a trader are to be shared.

22. The system of claim 14, wherein the at least one record of the order is for an uncommitted order.

23. The system of claim 14, wherein searching for a match for the notification message comprises comparing the notification message to a designated order.

24. The system of claim 14, wherein searching for a match for the notification message comprises comparing the notification message to an uncommitted order.

25. A system for performing a negotiated trade in a security comprising:
one or more processors that:
check for unusual activity in the security;
wait a random or semi-random period of time;
cause a trader to receive an indication that a negotiated trade has been initiated;
determine if a trade offer from the trader is at or better than the mid-point price in the security for a contra party to the trader;
if the trade is at or better than the mid-point price, accept the trade offer; and
execute the trade.

26. The system of claim 25, wherein the one or more processors also make a trade offer at the mid-point price for the security.

27. A computer-readable medium containing computer-executable instructions that, when executed by a processor, cause the processor to perform a method for trading securities, the method comprising:
accessing at least one record of an order in a trading blotter, the order having a security and side;
sending a notification message indicating the security and side for the order;
searching for a match for the notification message;
if a match is found, obtaining a quantity associated with the order; and
determining whether the quantity is adequate for executing a trade.

28. A computer-readable medium containing computer-executable instructions that, when executed by a processor, cause the processor to perform a method for performing a negotiated trade in a security, the method comprising:
checking for unusual activity in the security;
waiting a random or semi-random period of time;
causing a trader to receive an indication that a negotiated trade has been initiated;
determining if a trade offer from the trader is at or better than the mid-point price in the security for a contra party to the trader;
if the trade is at or better than the mid-point price, accepting the trade offer; and
executing the trade.
